(19) United States
(12) Patent Application Publication
(10) Pub. No.: US 2014/0361494 A1
(43) Pub. Date: Dec. 11, 2014

(54) SYSTEM, METHOD AND APPARATUS FOR SPRING-ENERGIZED DYNAMIC SEALING ASSEMBLY

(71) Applicant: Saint-Gobain Performance Plastics Corporation, Aurora, OH (US)

(72) Inventor: Jon M. Lenhert, Brea, CA (US)

(21) Appl. No.: 14/465,663

(22) Filed: Aug. 21, 2014

Related U.S. Application Data
(63) Continuation of application No. 12/965,047, filed on Dec. 10, 2010.
(60) Provisional application No. 61/285,587, filed on Dec. 11, 2009.

(51) Int. Cl. F16J 15/32

(52) U.S. Cl. CPC F16J 15/3208; F16J 15/3252
USPC 277/550

(57) ABSTRACT

A seal assembly is disclosed. The seal comprises a metal spring bonded to an elastomer body that is coupled to a polymer ring. The spring may comprise a cantilevered, overlapped metal strip. The elastomer and polymer mechanically interlock with radial members. The elastomer has contacting surfaces configured in outward extending radii to enhance forward edge loading and oil removal from the dynamic surface. In hydraulic service, the seal prevents the egress of hydraulic fluid and ingress of foreign particles.

### CROSS-REFERENCE TO RELATED APPLICATIONS

This application is a continuation and claims priority to U.S. patent application Ser. No. 12/965,047 entitled SYSTEM, METHOD AND APPARATUS FOR SPRING-ENERGIZED DYNAMIC SEALING ASSEMBLY, by Jon M. Lenhert, filed Dec. 10, 2010, which application claims priority under 35 U.S.C. §119(e) to U.S. Patent Application No. 61/285,587 entitled SYSTEM, METHOD AND APPARATUS FOR SPRING-ENERGIZED DYNAMIC SEALING ASSEMBLY, by Jon M. Lenhert, filed Dec. 11, 2009, of which both applications are assigned to the current assignee hereof and incorporated herein by reference in their entirety.

### BACKGROUND

1. Field of the Disclosure

The invention relates in general to seals and, in particular, to an improved system, method and apparatus for a spring-energized elastomer and polymer dynamic seal assembly.

2. Description of the Related Art

Dynamic seals for linear motion rods or cylinders that are used in hydraulic service prevent the loss of hydraulic fluid from the system, and the intrusion of foreign particles between the moving parts. The dynamic or relative motion surfaces may be located at either the inner or outer diameter of engagement. Conventional seals typically comprise elastomers that wear quickly or are prone to tear, or polymers that are more durable than elastomers but have a lower sealing capacity.

Conventional seals also typically have straight conical contact surfaces that limit forward edge loading of the seal and oil removal from the dynamic surface. Moreover, reverse shaft motion at such seals is reduced for shear or adhesion oil pumping. These limitations can result in excessive moisture in seals, which can permit more leakage or weepage. In addition, conventional seals have a limited operational temperature range, which is typically above −40° C. These design constraints further narrow the applications, velocity, pressure, chemistry and other physical constraints on the seals and their usefulness. Although known solutions are workable for some applications, an improved linear dynamic seal would be desirable.

### SUMMARY

Embodiments of a dynamic seal assembly are disclosed. When used in hydraulic service, the seal prevents the egress of hydraulic fluid and the ingress of foreign particles. In some embodiments, the sealing device is an assembly of three annular components. A metallic spring is joined to an elastomer body or cover that is coupled to a polymer ring. The spring may be die-formed from an overlapped metal strip, and may comprise a u-shaped cantilever design. The elastomer body and polymer ring mechanically interlock, such as with a radial member in a radial groove.

Embodiments of the elastomer body have radially outward extending surfaces with large radii at their contacting and sealing portions rather than conventional straight conical surfaces. This design enhances forward edge loading and oil removal from the dynamic surface. In some embodiments, reverse shaft motion at the seal is enhanced by the design for shear or adhesion oil pumping.

The foregoing and other objects and advantages of the embodiments will be apparent to those skilled in the art, in view of the following detailed description of the present invention, taken in conjunction with the appended claims and the accompanying drawings.

### BRIEF DESCRIPTION OF THE DRAWINGS

The present disclosure may be better understood and its numerous features and advantages made apparent to those skilled in the art by referencing the accompanying drawings.

FIG. 1 is a sectional side view of one embodiment of a linear dynamic sealing application shown with the seal assembly in a relaxed state and is constructed in accordance with the invention;

FIG. 2 is an enlarged sectional side view of one embodiment of a seal assembly in the linear dynamic sealing application of FIG. 1, and is constructed in accordance with the invention;

FIG. 3 is an enlarged sectional side view of another embodiment of a seal assembly for a linear dynamic sealing application shown with the seal assembly in a relaxed state and is constructed in accordance with the invention;

FIGS. 4 and 5 are partially-sectioned, isometric views of seal assemblies with alternate embodiments of springs and are constructed in accordance with the invention;

FIG. 6 is a sectional side view of an embodiment of the linear dynamic sealing application of FIG. 3 shown in a compressed state and is constructed in accordance with the invention; and

FIG. 7 is a sectional side view of another embodiment comprising a face seal assembly and is constructed in accordance with the invention.

The use of the same reference symbols in different drawings indicates similar or identical items.

### DESCRIPTION OF THE DRAWINGS

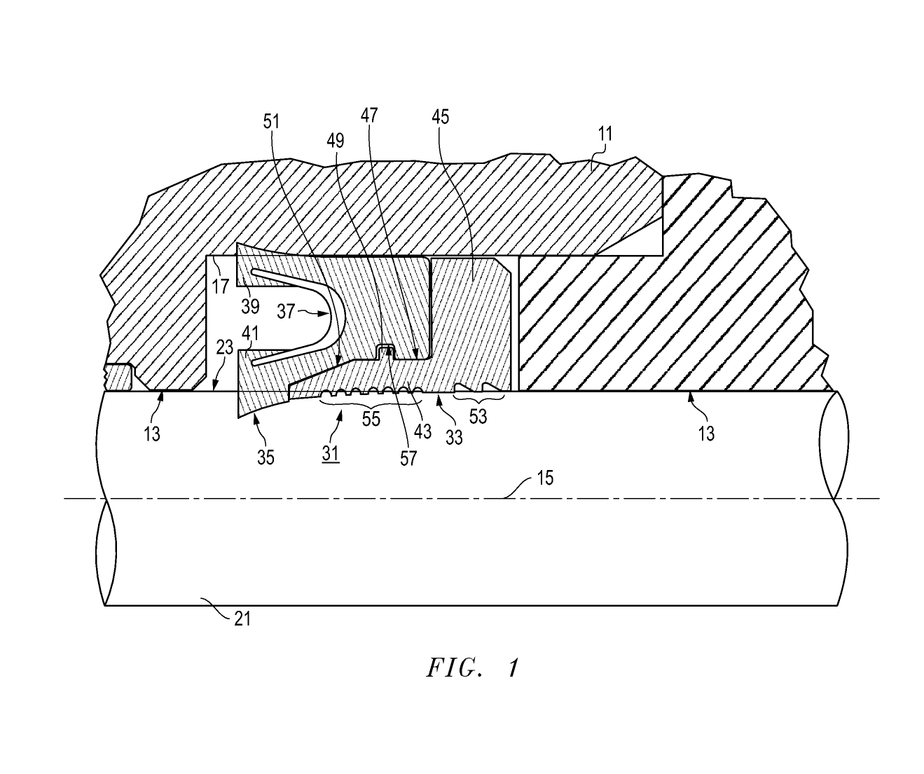

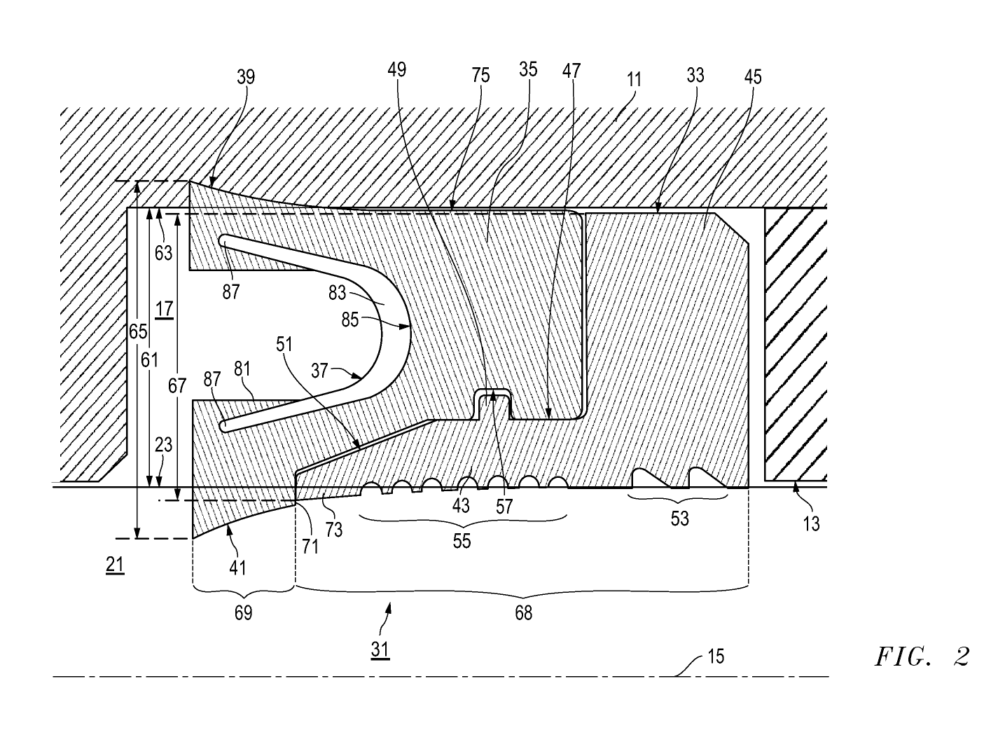

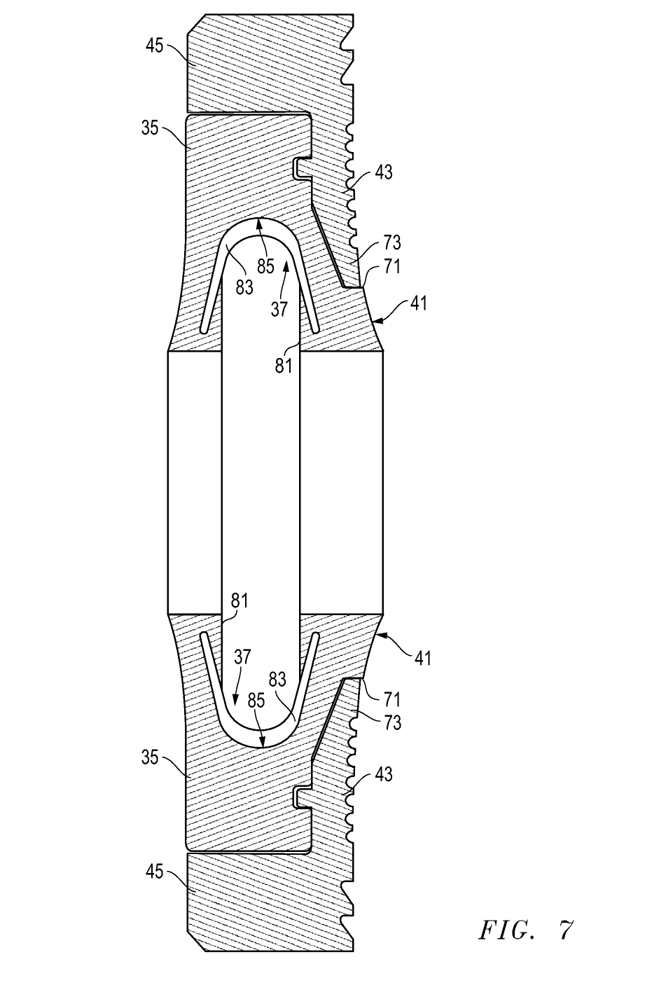

Referring to FIGS. 1-7, various embodiments of an improved system, method and apparatus for a dynamic seal assembly for, e.g., linear motion applications are disclosed. For example, FIGS. 1 and 2 disclose one embodiment of a system comprising a housing 11 having a bore 13 with an axis 15, and a gland or recess 17 located in the bore 13. A rod 21 is coaxially located in the bore 13 for axial motion relative to housing 11. The rod 21 has an outer surface 23 comprising a dynamic surface relative to bore 13, which has a static surface 63 (FIG. 2) in the embodiment shown.

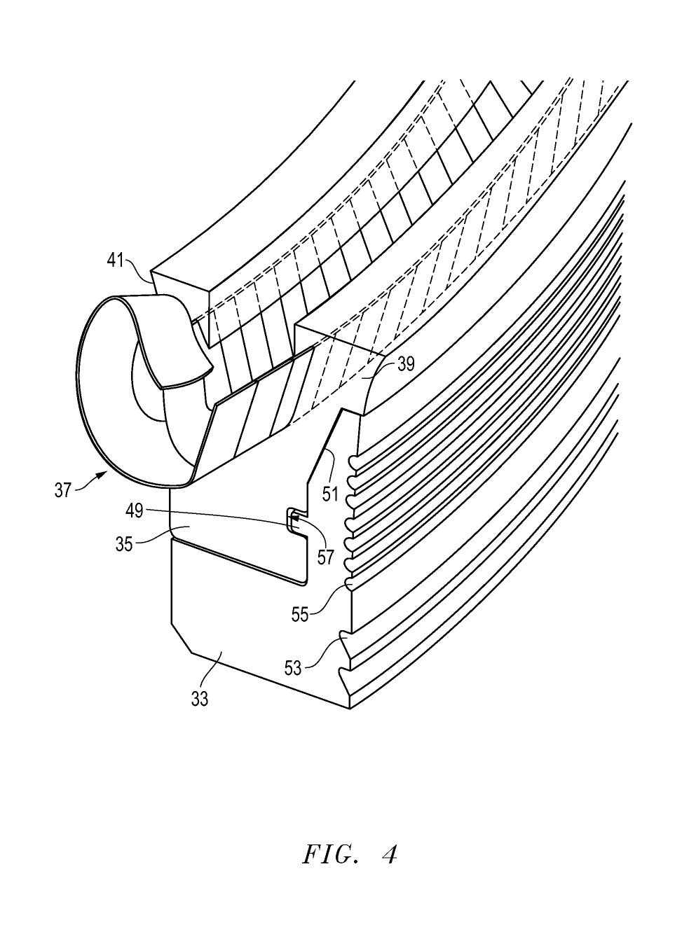

In some embodiments, a seal assembly 31 comprising a radial seal (e.g., FIGS. 1-3 and 6) is located in the recess 17 of the bore 13. Seal assembly 31 forms a seal between the housing 11 and the rod 21. In some versions, the seal assembly 31 comprises three annular components: a polymer ring 33, an elastomer body 35 joined to the polymer ring 33, and a spring 37 installed in the elastomer body 35. As best shown in FIG. 2, the spring 37 biases certain radial portions 39, 41 of the elastomer body 35 into radial contact with both the housing 11 and the rod 21 for providing a dynamic seal therebetween. In other embodiments (e.g., FIGS. 4, 5 and 7), the seal assembly 31 may be configured as a face seal which are commonly used to seal between parallel flat surfaces, swivel couplings and flange-type joints, for example.

The elastomer body 35 may be formed from an elastic material and adheres tightly around the polymer ring 33. In some embodiments, the elastomer comprises a polymer blend (e.g., filled) that has significantly lower hardness or modulus than the polymer ring 33. Other types of elastomer compounds also may be used, such as partially-fluorinated elastomers (FKMs) and fully fluorinated perfluoroelastomers (FFKMs), for example.

The polymer ring 33 and the elastomer body 35 also mechanically interlock via a radial member in a radial groove to further secure their union. For example, in the illustrated embodiment, an outer square rib 49 circumscribes polymer ring 33 and engages an inner square groove 57 that circumscribes elastomer body 35.

In some embodiments, the polymer ring 33 is securely locked as a unit to the elastomer component 35 via, e.g., the illustrated radial tongue and groove arrangement. This design allows for intimate positioning of the ring and the elastomer. The locking features permit the joinder of incompatible materials that cannot be bonded, such as a fluorosilicone elastomer and a fluoropolymer or fluoropolymer blend ring.

In the embodiment shown, the polymer ring 33 comprises a generally cylindrical or tubular portion 43 and a larger flange 45 on one axial end of portion 43. The radial outer surface 47 of the tubular portion 43 includes rib 49, which protrudes radially therefrom. A radial taper 51 extends from tubular portion 43 and is located opposite the flange 45. The radial taper 51 reduces both the inner and outer diameters of the polymer ring 33 at an opposite axial end to the flange 45. Overall, the polymer ring 33 has a generally L-shaped sectional profile, as shown in the illustrated embodiment.

The polymer ring 33 may further comprise one or more sets of concave grooves on or adjacent to the dynamic surface for the application. For example, polymer ring 33 may be provided with a first set of particulate rejection grooves 53, and a second set of fluid and particulate retention grooves 55 that are axially spaced apart from the first set of grooves 53. Grooves 55 are smaller in size but greater in number than grooves 53. Grooves 53 are located axially opposite the flange 45 and elastomer body 35. Grooves 55 are located axially between the grooves 53 and the elastomer body 35, and opposite rib 49. Both sets of grooves 53, 55 are located on a radial inner surface of the polymer ring 33 which, in this case, is a dynamic surface. The grooves 53, 55 on the dynamic side of the polymer beneficially entrap foreign particles and some lubricant to help reduce friction and reduce wear. The grooves also act as a scraping device.

As best shown in FIG. 2, the portions 39, 41 on elastomer body 35 may comprise radially extending surfaces that are configured with concave radii. The concave radii are located at the contacting portions with the housing 11 and rod 21. These portions 39, 41 extend in opposite directions and provide a compressive load biasing arc against the inner and outer hardware elements again which they seal. In FIGS. 1-3, portions 39, 41 are shown exaggerated into the hardware in an undeformed state as they would appear prior to installation between the housing 11 and rod 21.

A radial distance 61 between the rod 21 and the surface 63 on the housing 11 in the recess 17, is less than radial thicknesses 65, 67 of the radially thickest portions of both the elastomer body 35 and the polymer ring 33, respectively. Thus, the elastomer body 35 and polymer ring 33 elastically deform and are compressed in radial thickness when installed between the housing 11 and the rod 21. The thickest radial portions of both the polymer ring 33 and the elastomer body 35 are at their axial ends or tips and adjacent to the concave radii surfaces 39, 41. In addition, the thickest portion 65 of the elastomer body 35 is greater than the thickest portion 67 of the polymer ring.

In some embodiments, the polymer ring 33 comprises a total of about 50% to 90% of a dynamic contact face area 68 (FIG. 2) with rod 21, as shown. The elastomer body comprises a total of about 10% to 50% of the dynamic contact face area 69 with rod 21. In other embodiments, the polymer ring comprises about 70% to 80% of the dynamic contact face area, and the elastomer comprises about 20% to 30% of the dynamic contact face area.

In some embodiments, a radially inner one 41 of the radially extending surfaces 39, 41 extends from a rim 71 that protrudes radially inward from the elastomer body 35. The rim 71 of elastomer body 35 extends over or overlaps an axial end on a radial inner portion 73 of the polymer ring 33. A radially outer one 39 of the radially extending surfaces 39, 41 transitions smoothly from a flat outer radial surface 75 of the elastomer body 35, through an arcuate shape, and radially outward to the tip at the axial end.

In some embodiments of the invention, the metallic spring 37 is molded into and bonded (e.g., vulcanized) to the elastomer body 35. This design provides a more rigid assembly and suppresses spring cut-through. The spring also stabilizes the elastomer on the dynamic side (e.g., adjacent rod 21), thereby reducing the potential for lip tearing at the polymer interface 71, 73.

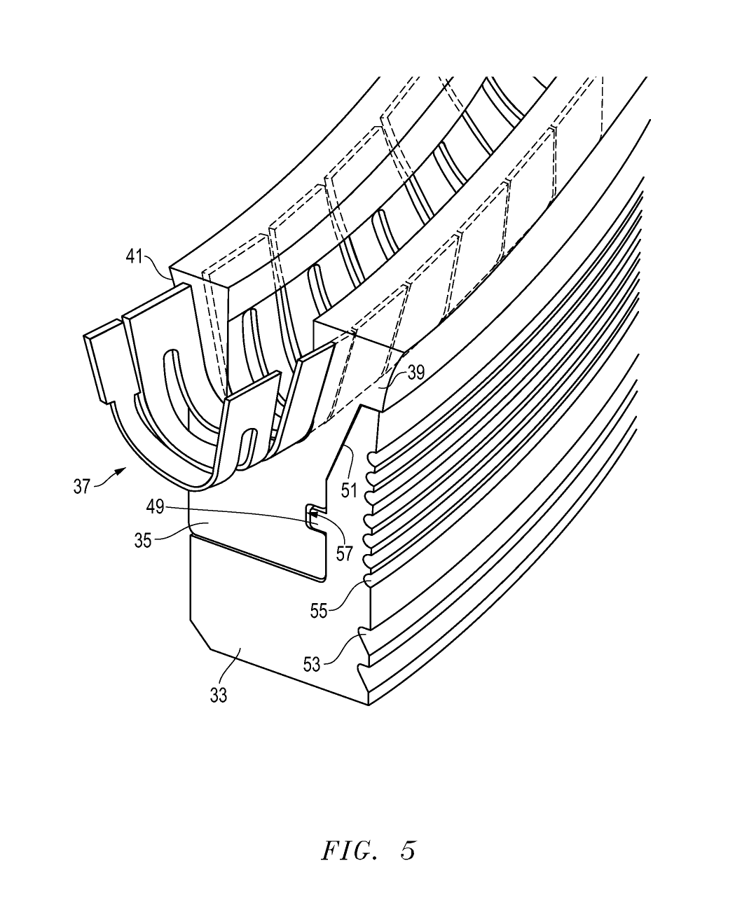

The elastomer body 35 may further comprise an annular opening 81 in an axial direction that is located opposite flange 45. Spring 37 is installed and seated in opening 81. In some embodiments, the spring 37 is metallic, bonded to the elastomer body 35, and free of direct contact with the polymer ring 33. As shown in FIG. 5, the spring 37 may be die-formed from an overlapped metal strip and configured with u-shaped cantilevers. Descriptions of other embodiments of the spring are further described herein.

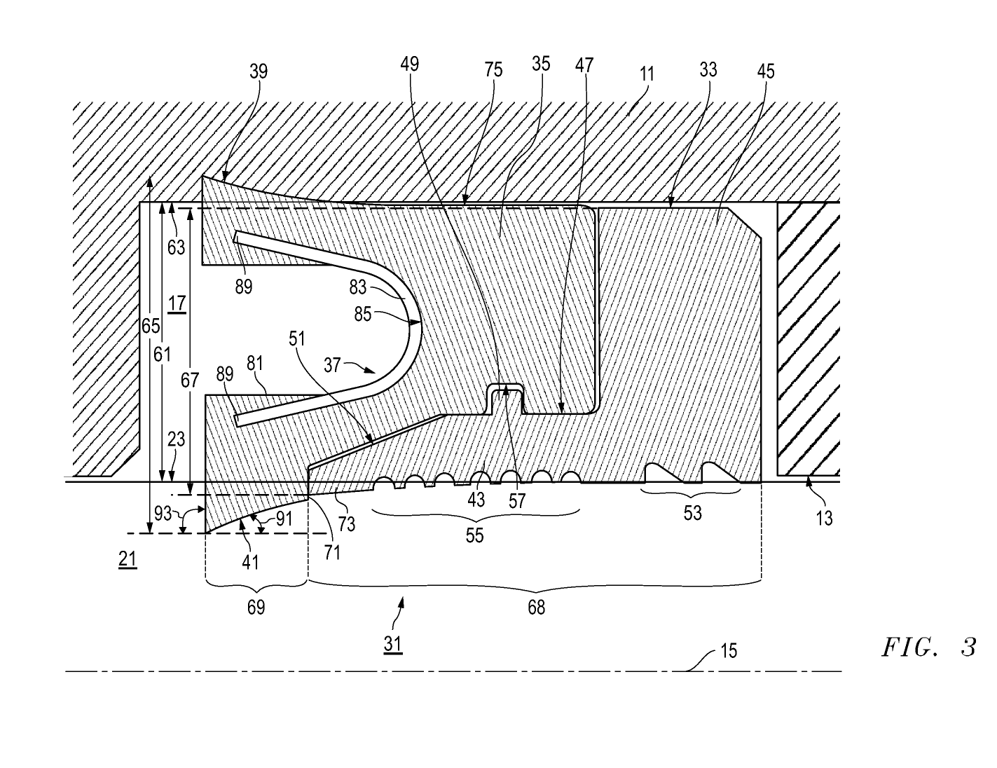

In the embodiment of FIG. 2, the spring 37 has an apex 83 that abuts an inner, concave surface 85 of the annular opening 81. The spring 37 is circumscribed with ends 87 that extend into and are embedded in the radial thicknesses of portions 39, 41 of the elastomer body 35. In the embodiments of FIGS. 1 and 2, the spring 37 comprises a sectional profile having a non-uniform thickness that is thickest at the apex 83 and tapers down in thickness to rounded ends 87. However, in the embodiment of FIG. 3, the spring 37 comprises a sectional profile having a uniform thickness and square ends 89.

These embodiments offer numerous advantages over conventional seal designs. The large radii surfaces at portions 39, 41 on the inner and outer sealing contact areas of the elastomer 35 enhance fluid removal from the dynamic and static surfaces. In operation, these arcuate surfaces compress flat against the contact surfaces of the housing and rod. When the elastomer is compressed as such, the elastomer adds additional loading to the front edge of the seal assembly to the dynamic surface. When relaxed, however, this design forms a small incident angle 91 (FIG. 3) of scraper face to hardware of less than 90°. A contact point back angle 93 in a nominal range of about 93° to 95° is formed by portions 39, 41 in the uncompressed state.

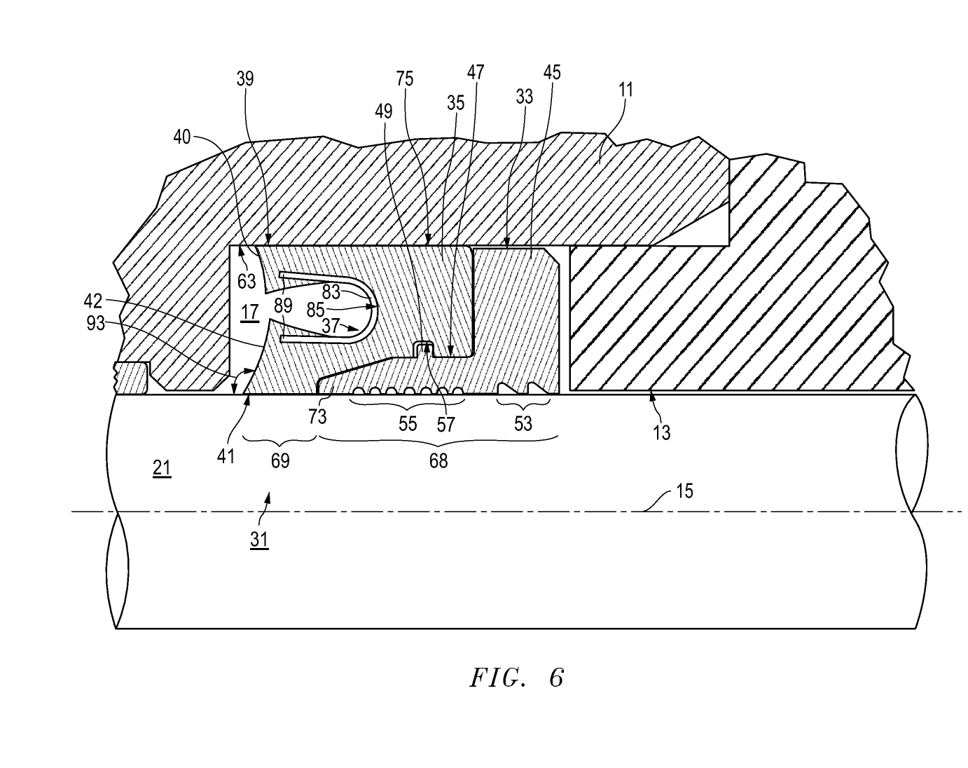

After installation and compression (see, e.g., FIG. 6), the angle 91 and polymer ring portion 73 flatten out and are substantially 0° and parallel to the axis 15. After installation, surfaces 40, 42 may deform from flat surfaces (see, e.g., FIG. 3) to the concave or arcuate surfaces (e.g., parabolic curves) shown in FIG. 6. In addition, angle 93 increases to approximately 100° at the shaft 21. The additional loading provided by the geometry of seal assembly 31 (e.g., angles 91 and 93) creates superior fluid dynamics and surface particle removal. As a result, the seal has a thinner oil film and is thus drier than conventional seals, and permits less leakage or weepage.

In some embodiments, the use of the polymer ring 33 with an “L” shaped sectional profile also has several advantages. The polymer acts as an anti-extrusion ring, closing the low pressure side hardware gap (e.g., adjacent housing 11). The polymer shape reduces the dynamic friction and shear stress on the elastomer by replacing a substantial dynamic contact face area with the low coefficient of friction of the polymer. The more polymer on the contact or dynamic surface, the lower the dynamic friction. The less elastomer, however, the higher the unit load. Thus, the elastomer wears faster than the polymer. In some embodiments, the polymer comprises about 70% to 80% of the dynamic contact face area, with the remainder being elastomer.

The presence of spring 37 in these seal systems allows for temperature use below the traditional −40° C. and, with a proper selection of spring and elastomer, a usable range to −100° C. The spring 37 and large radii 39, 41 of the elastomer 35 help handle the high viscosities of fluids in those temperature ranges. In addition, the polymer ring 33 grips the shaft 21 better when cold, helping to scrape away shaft born ice.

The die-formed, overwrapped, helical spring-equipped seal 11 disclosed herein has radii at its leading edges, and is much less prone to cut-through of the elastomer jacket. As shown in FIG. 4, the spring 37 may comprise a semi-helical wound ribbon, with about 30% overlap on each turn. Typically, the spring has no gaps between turns. A torus of the spring stock is placed in a circular male/female “V” groove forming die, which forms the final shape. The spring may be formed from a high tensile material that can be rolled into sheet and punched or roll-formed, such as spring metals, nickel, ferrous, or copper-based alloys. The elastomer may be molded from materials that are commercially suitable for use as o-rings, such as isobutylisoprene.

In some embodiments, the polymer component may comprise a low friction wearing material, such as hard nylon, fluoroplastics, PBI, PEEK, PAEK, PFA, FEP, TFM, PI, PAI, or any moderate to high modulus plastic compatible with the temperature, chemistry, and pressure-velocity of the installation. In some embodiments, a metal that compliments the shaft may be used, such as brass on a steel shaft. However, the use of metal may lose some advantages of the ring. Because this component is not tensile stressed, the material is chosen for the application, temperature range, velocity, pressure, chemistry, machinability, cost, or other physical constraints.

Applications for such embodiments include, for example, hydraulic systems and aircraft suspensions. A seal constructed in accordance with the invention reduces friction in linear dynamic sealing assemblies and eliminates issues associated with conventional seal designs.

This written description uses examples, including the best mode, and also to enable those of ordinary skill in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

I claim:

1. A system for linear motion, comprising:
a housing having a bore;
a rod located in the bore for axial motion relative thereto, the rod having an outer surface;
a seal assembly located in the bore for sealing between the housing and the rod, the seal assembly comprising:
a polymer ring;
an elastomer body joined to the polymer ring, the elastomer body comprising:
an axial end defining a contact point back angle of greater than 90° as measured with respect to the outer surface of the rod, and
a scraper face contacting the rod along the entire axial length of the scraper face, the scraper face terminating at the axial end of the elastomer body, wherein, prior to installation of the seal assembly between the housing and the rod, the scraper face is concave along an entire axial length thereof; and
a spring joined to the elastomer body for biasing portions of the elastomer body into contact with both the housing and the rod.

2. The system according to claim 1, wherein, prior to installation of the seal assembly between the housing and the rod, the scraper face has an incident angle of less than 90°.

3. The system according to claim 1, wherein, prior to installation of the seal assembly between the housing and the rod, the scraper face has a minimum diameter and a maximum diameter, and wherein the minimum and maximum diameters are disposed at opposite axial ends of the scraper face.

4. The system according to claim 3, wherein the minimum diameter is disposed at the axial end of the elastomer body.

5. The system according to claim 1, wherein, prior to installation of the seal assembly between the housing and the rod, the axial end of the elastomer body defines an approximately 90° angle with respect to the rod.

6. A system for linear motion, comprising:
a housing having a bore;
a rod located in the bore for axial motion relative thereto, the rod having an outer surface;
a seal assembly located in the bore for sealing between the housing and the rod, the seal assembly comprising:
a polymer ring;
an elastomer body joined to the polymer ring, the elastomer body comprising:
a base portion defining a first axial end of the elastomer body; and
a first arm portion defining a second axial end of the elastomer body,
wherein the first arm portion defines a scraper face contacting the rod along the entire axial length of the scraper face, wherein the second axial end of the elastomer body defines a contact point back angle of greater than 90° as measured with respect to the outer surface of the rod, and wherein prior to installation of the seal assembly between the housing and the rod, the entire scraper face is concave with respect to the first arm portion; and p2 a spring joined to the elastomer body for biasing portions of the elastomer body into contact with both the housing and the rod.

7. The system according to claim 6, wherein, prior to installation of the seal assembly between the housing and the rod, the scraper face has a minimum diameter and a maximum diameter, and wherein the minimum and maximum diameters are disposed on opposite axial locations of the scraper face.

8. The system according to claim 7, wherein the minimum diameter is disposed at the second axial end of the elastomer body.

9. The system according to claim 6, wherein the scraper face provides a load biasing arc against the rod.

10. The system according to claim 6, wherein the polymer ring comprises a first set of particulate rejection grooves, and a second set of fluid and particulate retention grooves axially spaced apart from the first set of particular rejection grooves.

11. The system according to claim 10, wherein the first set of particular grooves comprise a non-symmetrical cross-sectional configuration.

12. The system according to claim 6, wherein the scraper face terminates at the second axial end of the elastomer body.

13. The system according to claim 6, wherein the contact point back angle is approximately 100°.

14. The system according to claim 6, wherein, prior to installation of the seal assembly between the housing and the rod, the scraper face has an incident angle of less than 90°.

15. The system according to claim 6, wherein the spring is bonded to the elastomer body.

16. The system according to claim 6, wherein, prior to installation of the seal assembly between the housing and the rod, the second axial end of the first arm portion defines an approximately 90° angle with respect to the rod.

17. A system for linear motion, comprising:
a housing having a bore;
a rod located in the bore for axial motion relative thereto, the rod having an outer surface;
a seal assembly located in the bore for sealing between the housing and the rod, the seal assembly comprising:
a polymer ring;
an elastomer body joined to the polymer ring, the elastomer body having:
a scraper face contacting the rod along the entire axial length of the scraper face, wherein, prior to installation of the seal assembly between the housing and the rod, at least a portion of the scraper face is concave with respect to the elastomer body; and
a spring joined to the elastomer body for biasing portions of the elastomer body into contact with both the housing and the rod.

18. The system according to claim 17, wherein the elastomer body has an axial end, and wherein the scraper face terminates at the axial end.

19. The system according to claim 18, wherein the axial end defines a contact point back angle of greater than 90° as measured with respect to the outer surface of the rod.

20. The system according to claim 17, wherein prior to installation of the seal assembly between the housing and the rod, the scraper face has a minimum diameter disposed at an axial end of the elastomer body.
